(19) United States
(12) Patent Application Publication
(10) Pub. No.: US 2005/0156576 A1
(43) Pub. Date: Jul. 21, 2005

(54) Charging apparatus for portable computer

(75) Inventors: Yan-Kin Chen, Taipei City (TW); Hsiao-Chung Lee, Hsi Chih City (TW); Ting-Hung Wu, Hsinchuang City (TW)

Correspondence Address: TROXELL LAW OFFICE PLLC, 5205 LEESBURG PIKE, SUITE 1404, FALLS CHURCH, VA, 22041, US

(73) Assignee: Cleve Co.

(21) Appl. No.: 11/028,597

(22) Filed: Jan. 5, 2005

(30) Foreign Application Priority Data
Jan. 16, 2004 (TW) 93200931

(51) Int. Cl. H02J 7/04

(52) U.S. Cl. 320/141

(57) ABSTRACT

A charging apparatus for portable computer can charge various batteries and adjust the charging current by itself. The charging apparatus has a converter, a processor, a PWM circuit connected to the converter and the processor for supplying a charging power, a battery connected to the PWM circuit, a current detection circuit connected to the processor, the PWM circuit and the battery, a battery status detection circuit connected to the battery and the processor, and a power consumption circuit connected to the converter, the PWM circuit and the processor.

### BACKGROUND OF THE INVENTION

1. Field of the Invention

The present invention relates to a charging apparatus for portable computer, and more specifically, relates to a charging apparatus, which can charge a variety of batteries in a portable computer.

2. Description of the Related Art

The computer has developed speedily since the world has become computerized, and, in particular, the portable computer has advanced greatly in miniaturization. The portable computer needs a battery to supply power, and the battery should be a rechargeable battery.

FIG. 1 is a schematic diagram of a prior art charging apparatus for a portable computer. The charging apparatus 1 of the prior art 1 uses a converter 12 to convert AC power into DC power, and a processor 14 is connected to the converter 12 and the battery 18 to detect the status of the battery 18. If the power of the battery 18 is lower than a low threshold, the processor 14 transmits a charging enable signal to a charging circuit 16, which is connected to the processor 14 and the battery 18.

At the same time, the charging circuit 16 charges the battery 18 with DC power. When the power of the battery 18 reaches a high threshold, the processor 14 detects the status of the power of the battery 18, and transmits a charging disable signal to the charging circuit 16 to stop charging.

In the above-mentioned, the circuit of the charging apparatus 1 of the prior art is complicated and expensive. Moreover the charging apparatus 1 of the prior art cannot charge a variety of batteries, spends much time to charge, and cannot charge a battery according to the power consumption of the portable computer. When the system of the portable computer is updated, it must change to use a converter of higher power.

### SUMMARY OF THE INVENTION

The primary object of the present invention is to provide a charging apparatus for a portable computer, which apparatus uses a power consumption circuit to detect power consumption, uses a current detection circuit to detect the current of the charging power, and uses the battery-status detection circuit to detect the status of the temperature and the voltage of the battery. In the above-mentioned, the power consumption, the charging power, and the status of the temperature and the voltage for the battery are transmitted to the processor to process. After processing, the processor controls a PWM circuit to supply a charging power to charge the battery with DC power.

In the present invention, the processor is connected to the power consumption circuit, the current detect circuit and the battery status detect circuit. The processor receives the system data from those circuits, and processes them. After processing, the processor controls the PWM circuit to supply a charging power to charge the battery with DC power.

In the above-mentioned, the present invention only uses the processor to control the PWM circuit to supply a charging power to charge the battery. This simplifies the components of the charging apparatus of the prior art.

Furthermore, the present invention uses the sample detect circuits and the processor to complete the charging of various batteries. Moreover the charging power is self-adjusted by the power consumption. When the power consumption drops, the charging current is increased to reduce the charging time. When the power consumption increases, the charging current is reduced or stopped to make the system work. Therefore, the present invention enhances the efficiency of the converter to reduce the cost.

### BRIEF DESCRIPTION OF THE DRAWINGS

The various objects and advantages of the present invention will be more readily understood from the following detailed description when read in conjunction with the appended drawing, in which:

FIG. 1 is a schematic diagram of the charging apparatus for portable computer of the prior art;

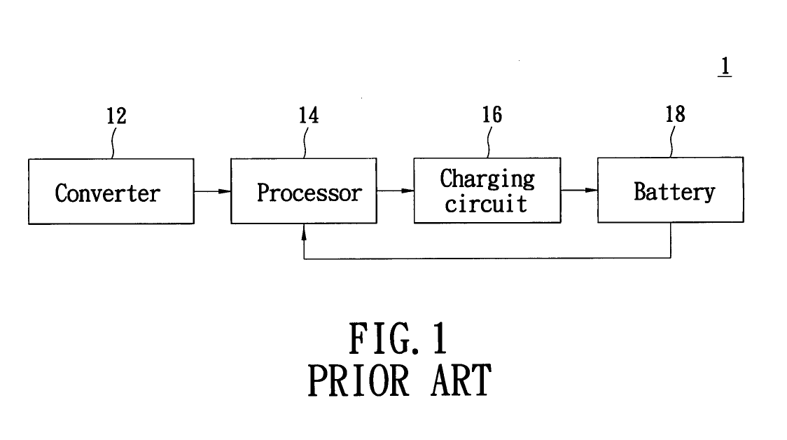

FIG. 2 is a schematic diagram of the charging apparatus for portable computer of the present invention;

FIG. 3 is a schematic diagram explaining the charging method of the present invention;

FIG. 4A is a circuit schematic diagram of the converter and the power consumption circuit of the present invention;

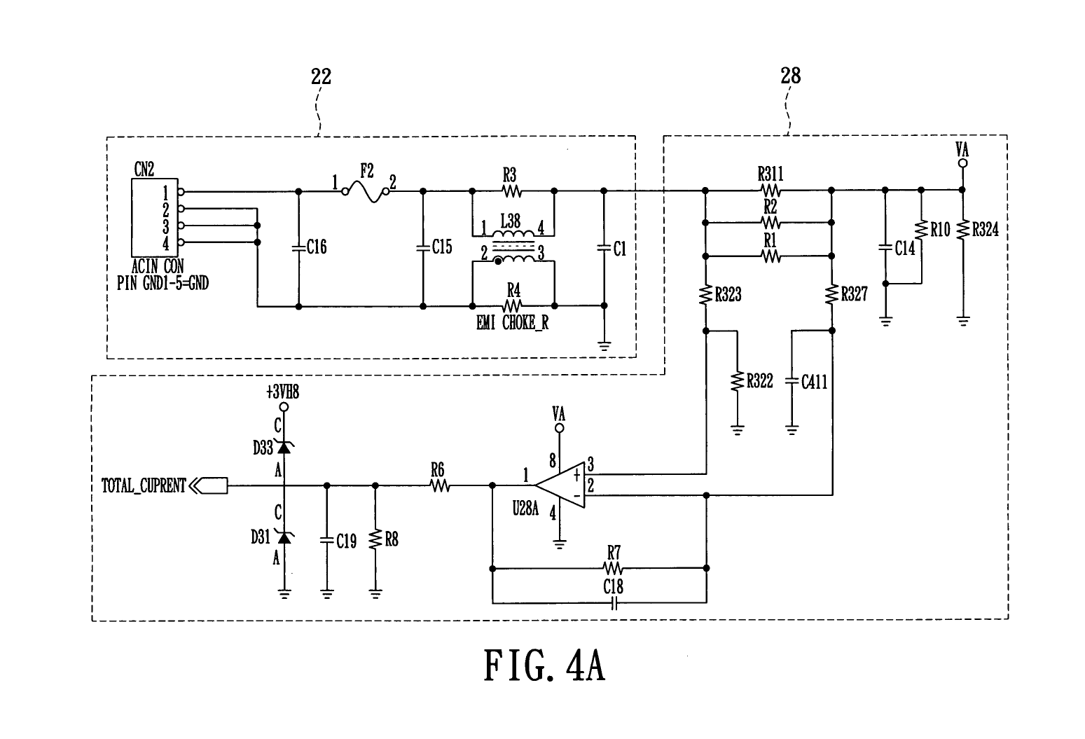

FIG. 4B is a circuit schematic diagram of the PWM circuit, the current detects circuit, the battery and the battery status detects circuit of the present invention; and

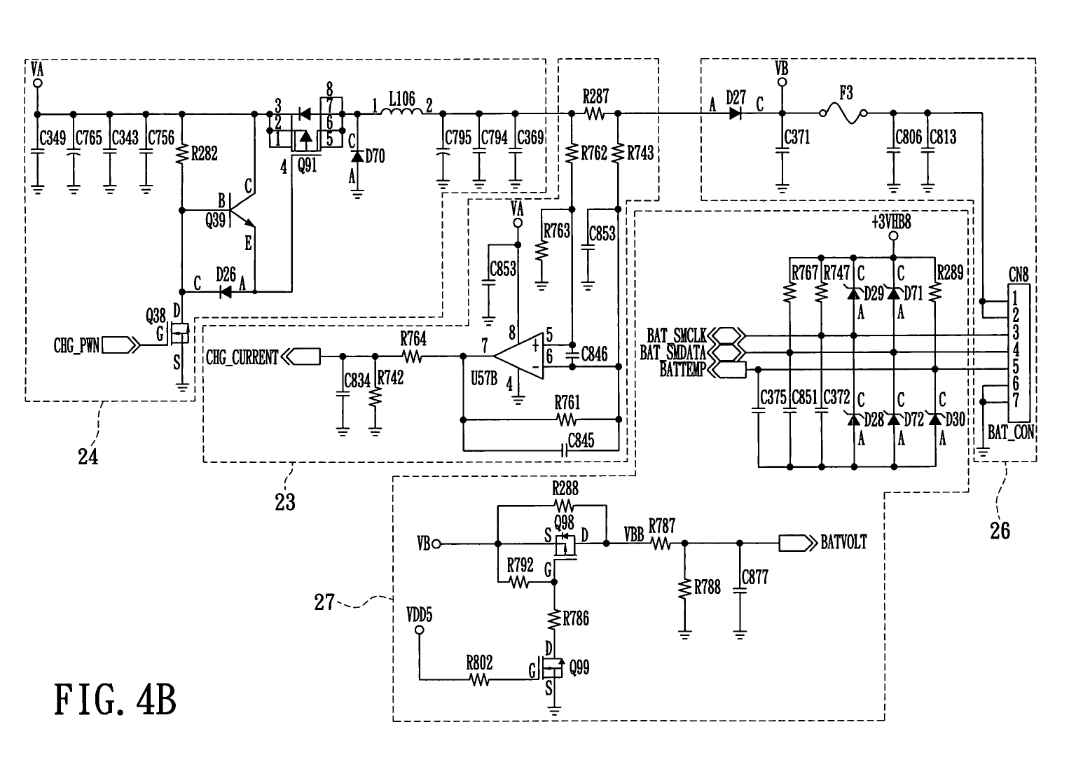

FIG. 4C is a circuit schematic diagram of the processor of the present invention.

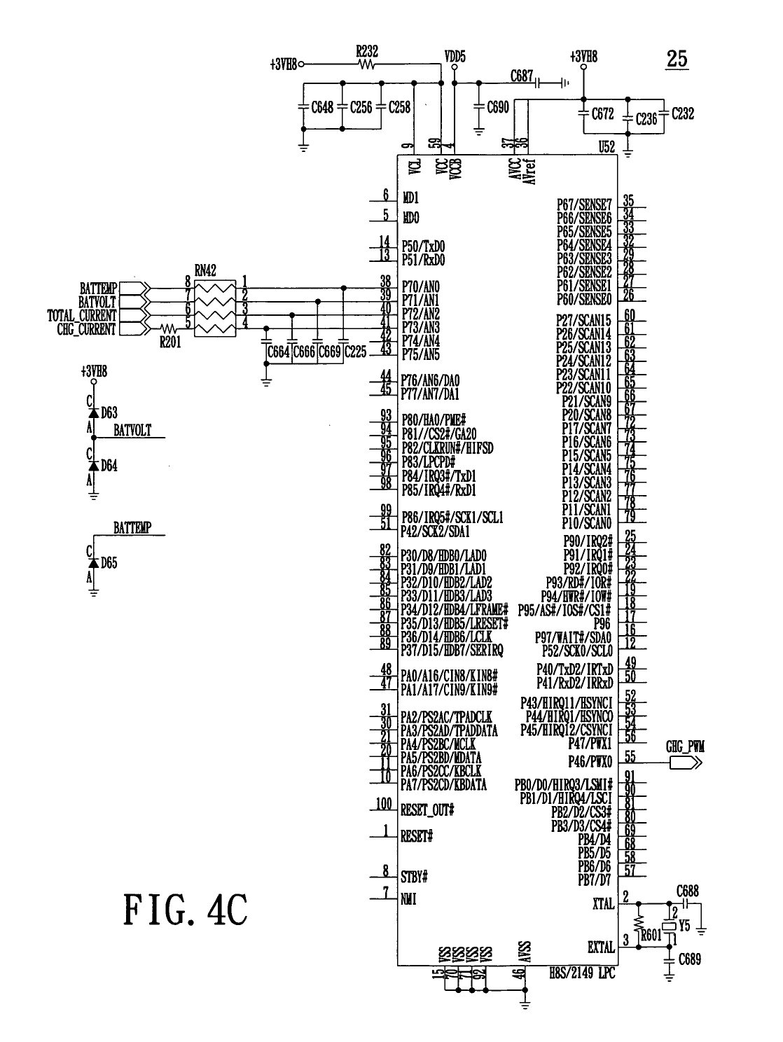

### DETAILED DESCRIPTION OF PREFERRED EMBODIMENTS

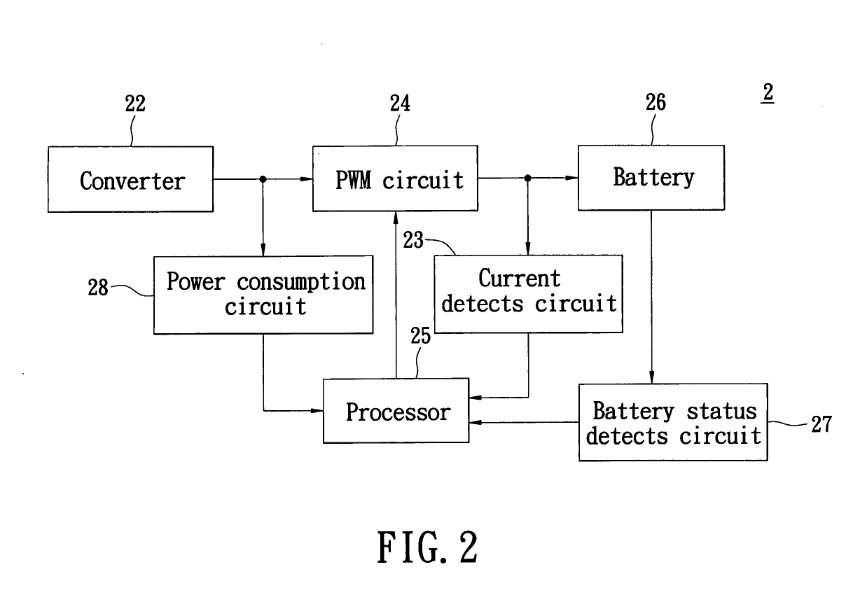

FIG. 2 is a schematic diagram of the charging apparatus for portable computer of the present invention. The charging apparatus 2 comprises a converter 22, a current detection circuit 23, a PWM circuit 24, a processor 25, a battery 26, a battery status detection circuit 27 and a power consumption circuit 28.

Referring to FIG. 2, the charging apparatus 2 is supplied power by the converter 22 converting the AC power to DC power. Power consumption circuit 28 is connected to converter 22 and the processor 25 for detecting the power consumption, and a power consumption data is transmitted to the processor 25.

Referring to FIG. 2, the PWM circuit 24 is connected to the processor 25, the converter 22, the battery 26 and the power consumption circuit 28, and is controlled by the processor 25 for supplying a charging power with DC power. The charging power is used to charge the battery 26.

Referring to FIG. 2, the current detects circuit 23 is connected to the processor 25, the PWM circuit 24 and the battery 26 for detecting the current of the charging power, and transmitting the current data to the processor.

Referring to FIG. 2, the battery status detection circuit 27 is connected to the processor 25 and the battery 26 for detecting the status of the battery 26, and transmitting the status data to the processor.

In the above-mentioned, the status of the battery 26 includes the status of the temperature and the voltage .for the battery 26. The battery 26 is a Li-ion (Lithium-ion) battery and a Ni—MH (nickel-Metal Hydrogen) battery.

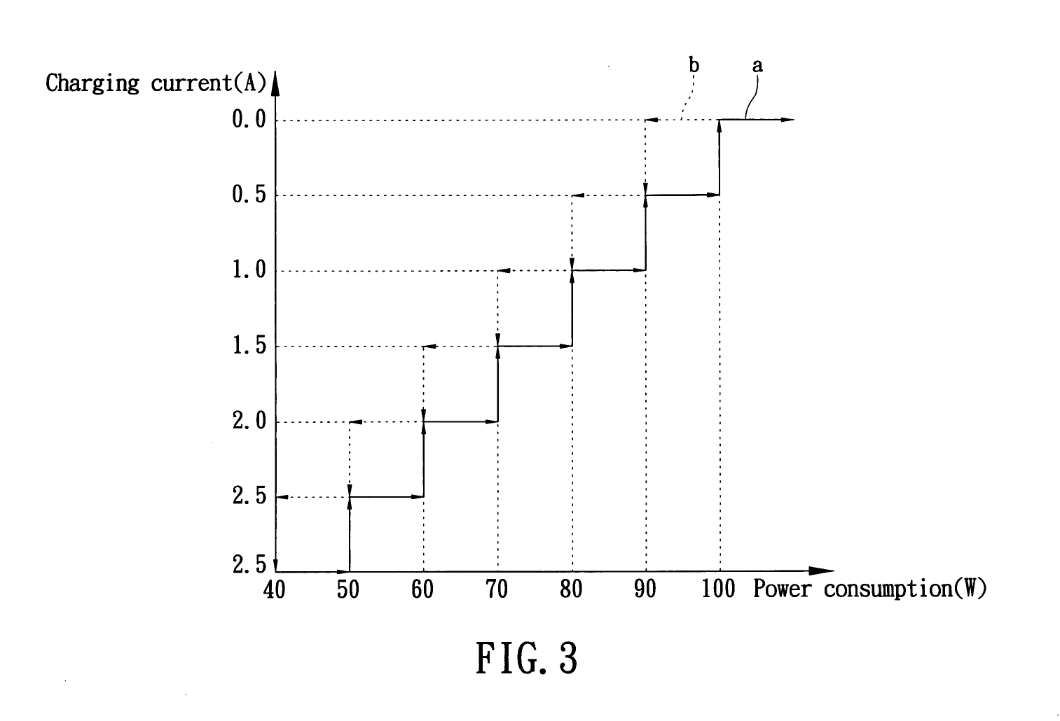

With reference also to FIG. 2, FIG. 3 shows a schematic diagram explaining the charging method of the present invention. The vertical axis indicates the charging current (A) and the horizontal axis indicates the power consumption (W). In FIG. 3, when the power consumption is 40 W (as indicated by the solid line a), the processor 25 receives the power consumption data from the power consumption circuit 28, receives the current data of the charging power from the current detects circuit and receives the status data of the temperature and the voltage for the battery 26. In the above-mentioned, after processing the data, the processor 25 controls the PWM circuit 24 to supply a charging power for charging the battery 26 with DC power, at which time the current of the charging power is 2.5 A.

In FIG. 3, when the power consumption rises to 60 W, the current of the charging power drops to 2.0 A (as indicated by the solid line a), and the apparatus ceases operation. When the power consumption rises to 100 W, the current of the charging power drops to 0.0 A.

In FIG. 3, when the power consumption drops to 90 W from 100 W, the current of the charging power rises to 0.5 A (as indicated by the dotted line b). Moreover, when the power consumption drops, the current of the charging power rises.

In the above-mentioned, when the power consumption rises, the current of the charging power drops, and on the other hand, when the power consumption drops, the current of the charging power rises. Then the present invention adjusts the charging current to reduce the charging time by detecting the power consumption. Moreover the present invention enhances the efficiency of the converter 22 to reduce the cost and the circuit-complexity.

The features of the present invention are listed as follows:
1. Low cost with simple circuits.
2. Charging for various batteries.
3. Self-adjusted charging current according to the power consumption.
4. Enhancing the efficiency of the converter to reduce the cost.

Those skilled in the art will readily observe that numerous modifications and alterations of the device may be made while retaining the teachings of the invention. Accordingly, the above disclosure should be construed as limited only by the metes and bounds of the appended claims.

1. A charging apparatus for portable computer, comprising:
a converter for converting power from AC to DC;
a processor;
a PWM circuit to supply a charging power for battery by connecting to said converter and controlled by said processor;
a battery connected to said PWM circuit;
a current detection circuit connecting to said PWM circuit to detect the amount of a charging current for said battery, and transmitting data of said charging current to said processor;
a battery status detection circuit connecting to said battery to detect status of said battery, and transmitting data of said status to said processor; and
a power consumption circuit connecting to said converter to detect power consumption, and transmitting data of the power consumption to said processor.

2. The charging apparatus of claim 1, wherein the battery status detects circuit detects a temperature and a voltage of the battery.

3. The charging apparatus of claim 1, wherein the battery is a Ni—MH battery.

4. The charging apparatus of claim 1, wherein the battery is a Li-ion battery.
